(19) United States
(12) Patent Application Publication
(10) Pub. No.: US 2015/0170048 A1
(43) Pub. Date: Jun. 18, 2015

(54) Determining a Type of Predictive Model for Training Data

(71) Applicants: Wei-Hao Lin, New York, NY (US); Travis H.K. Green, New York, NY (US); Robert Kaplow, New York, NY (US); Gang Fu, Kearny, NJ (US); Gideon S. Mann, New York, NY (US)

(72) Inventors: Wei-Hao Lin, New York, NY (US); Travis H.K. Green, New York, NY (US); Robert Kaplow, New York, NY (US); Gang Fu, Kearny, NJ (US); Gideon S. Mann, New York, NY (US)

(21) Appl. No.: 13/209,358

(22) Filed: Aug. 12, 2011

(51) Int. Cl. G06N 99/00; G06N 5/04

(52) U.S. Cl. CPC G06N 99/005; G06N 5/048

(57) ABSTRACT

A computer-implemented method includes receiving, in a system of one or more computers, training data for predictive modeling, the training data including a plurality of categories; determining, by the system, one or more attributes of the training data; identifying, by the system in a mapping of attributes to types of predictive models, a type of predictive model that is mapped to at least one of the one or more attributes; obtaining a utility function for the predictive model of the identified type, the utility function specifying importance of the plurality of categories relative to each other; and generating, based on the training data and the utility function, a predictive model of the identified type.

### BACKGROUND

Predictive modeling generally refers to techniques for extracting information from data to build a model that can predict an output from a given input. Predicting an output can include predicting future trends or behavior patterns, or performing sentiment analysis, to name a few examples. Various types of predictive models can be used to analyze data and generate predictive outputs. Examples of predictive models include Naive Bayes predictive models, k-nearest neighbor predictive models, support vector predictive models, and logistic regression predictive models, for example. Typically, a predictive model is trained with training data that includes input data and output data that mirror the form of input data that will be entered into the predictive model and the desired predictive output, respectively. The amount of training data that may be required to train a predictive model can be large, e.g., in the order of gigabytes or terabytes. The number of different types of predictive models available is extensive, and different models behave differently depending on the type of input data. Additionally, a particular type of predictive model can be made to behave differently, for example, by adjusting the hyper-parameters or via feature induction or selection.

### SUMMARY

This specification describes technologies for determining a type of predictive model for training data for use in predictive models.

In general, one innovative aspect of the subject matter described in this specification can be embodied in methods that include the actions of receiving, in a system of one or more computers, training data for predictive modeling, the training data including a plurality of categories; determining, by the system, one or more attributes of the training data; identifying, by the system in a mapping of attributes to types of predictive models, a type of predictive model that is mapped to at least one of the one or more attributes; obtaining a utility function for the predictive model of the identified type, the utility function specifying importance of the plurality of categories relative to each other; and generating, based on the training data and the utility function, a predictive model of the identified type.

These and other embodiments can each optionally include one or more of the following features. In some aspects, the method also includes training the predictive model with the training data. In other aspects, training includes: determining one or more patterns in the training data.

In still other aspects, the determined type of predictive model includes one or more of a k-nearest neighbor predictive model, a logistic regression predictive model, a Naive Bayes predictive model, and a support vector predictive model. In some aspects, the one or more attributes include one or more of a size of the training data, an estimate of an amount of time required to train a predictive model with the training data, a number of categories in the training data, and a number of features of the training data.

In yet other aspects, the predictive model of the identified type includes the k-nearest neighbor predictive model, and the method further includes: receiving input data; identifying, from the k-nearest neighbor predictive model, a k-nearest item of data that is closest to the input data, relative to closeness of other k-nearest items of data to the input data; and assigning to the input data a category associated with the identified k-nearest item data.

Other embodiments of these aspects include corresponding systems, apparatus, and computer programs, configured to perform the actions of the methods, encoded on computer storage devices.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for determining a type of predictive model to be applied to training data.

FIG. 2 illustrates contents of a mapping in a k-nearest neighbor predictive model.

FIG. 3 is a flowchart of an example process for determining a type of predictive model.

FIG. 4 is a flowchart of an example process for using a utility function in a k-nearest neighbor predictive model.

FIG. 5 is a schematic diagram of an example server.

Like reference numbers and designations in the various drawings indicate like elements.

### DETAILED DESCRIPTION

In various implementations, a predictive model (or “model”) is either a categorical model if its predictions are categories, or is a regression model if its predictions are numeric. A predictive model is trained using training data. Training data encompasses examples that each comprise one or more data fields plus an answer (a category or a numeric value) for that example. By way of illustration, the training data in the below Table 1 consists of six examples, with each example including an email message subject line and a category that indicates whether each example represents SPAM or not.

TABLE 1

| EXAMPLE NUMBER | EMAIL SUBJECT LINE | CATEGORY |
|---|---|---|
| Example 1 | “You have won $$$” | “spam” |
| Example 2 | “Lose weight fast!” | “spam” |
| Example 3 | “Lowest interest rates ever!” | “spam” |
| Example 4 | “How are you?” | “not spam” |
| Example 5 | “Trip to New York” | “not spam” |
| Example 6 | “Secrets of extreme weight | “spam” |
| | loss!!” | |

After a model has been trained against training data, input data (e.g., queries) can be submitted to the model. In some implementations, the input data is similar in form to training examples: that is, the input data has the same or fewer data fields but does not include the answer. The trained model uses patterns that it learned from the training data to either find the closest category for the submitted input data (if it is a categorical model) or estimate an output value for the input data (if it is a regression model), and returns the category or value.

Certain types of predictive models provide increased performance (e.g., increased efficiency and/or increased accuracy) for certain types of training data, e.g., relative to the performance provided by other types of predictive models. The system described herein uses attributes of the training data to determine a type of predictive model that provides increased performance for a set of training data, e.g., relative to the performance provided by other types of predictive models. Attributes of the training data may include, for example, a size of the training data, an estimate of an amount of time required to train a predictive model using the training data, and a number of features in the training data.

In an example, features include individual data units that as a set form the input data that corresponds to a specific output. In this example, the system determines whether an email is spam. The features include data units indicative of text in a body of the email, data indicated of an address for a sender of the email, data indicative of a length of the email, data indicative of whether the recipient of the email has previously received an email from the sender, and so forth.

Attributes of the training data may also include attributes of the categories included in the training data, including, e.g., a number of categories included in the training data, a number of examples provided per category, and so forth.

In an example, the system is configured to identify sets of training data for which the k-nearest neighbor predictive model provides increased performance, e.g., relative to the performance provided by the other predictive models. In this example, a set of training data includes more than one-hundred different categories. The system determines that when there are more than one-hundred different categories that the k-nearest neighbor predictive model provides a prediction with increased accuracy relative to the accuracy of predictions provided by other predictive models, including, e.g., a logistic regression predictive model, a Naive Bayes predictive model, a support vector predictive model, and so forth. When there are less than one-hundred different categories, the k-nearest neighbor predictive model consumes an increased amount of memory (e.g., relative to an amount of memory consumed by other predictive models), while producing results with decreased accuracy (e.g., relative to an accuracy provided by other predictive models), because there is often not enough data for the k-nearest neighbor predictive model to make fine-grained distinctions

In another example, another set of training data includes hundreds of examples for one category, but only a few examples for another category. In this example, the system determines when there are uneven numbers of examples for the various categories of the training data that a logistic regression predictive model provides a prediction with increased accuracy relative to the accuracy of other predictive models, including, e.g., a k-nearest neighbor predictive model. If there are few categories, then it's easy to draw distinctions among the categories. This means that logistic regression predictive models are good candidate models, e.g., because logistic regression predictive models are faster than k-nearest neighbor predictive models.

For the sets of training data for which the k-nearest neighbor predictive model provides increased performance, e.g., relative to the performance provided by the other predictive models, the system is further configured to apply a utility function to the training data. Generally, a utility function includes information indicative of a correspondence among one or more weighted values and one or more items of training data. For example, a utility function may specify weighted value(s) to be applied to items of training data for particular categories. In a set of training data, a weighted value for an item of training data specifies the importance of the item of training data relative to the importance of the other items of training data in the set of training data. Using the training data and the utility function, the system generates a mapping to be used with the k-nearest neighbor predictive model, as described in further detail below.

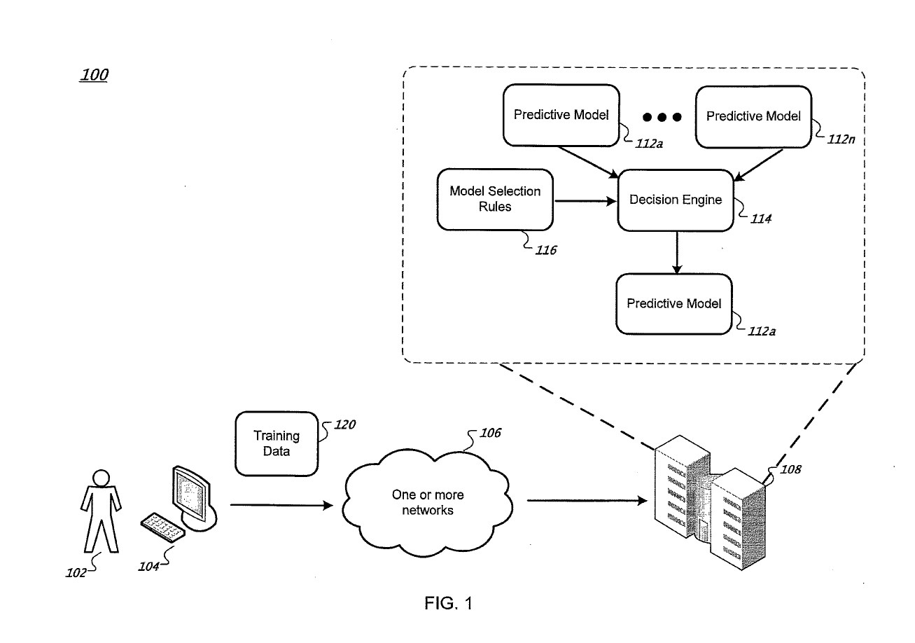

FIG. 1 illustrates an example system 100 for determining a type of predictive model for training data 120. System 100 includes client computing device 104 (or “client”) that can communicate through one or more networks 106 with a collection of server computing devices (or “servers”), such as servers deployed in data center 108 or in different geographic locations. A given server includes one or more data processing apparatus. Data center 108 may house hundreds or thousands of servers. The servers can communicate with each other and with storage systems (not shown) at various times using one or more computer networks or other communication means. For example, the servers in data center 108 can be coupled to an intranet. A computer program can execute on a single server or, alternatively, the program can be organized into components that execute on multiple servers. There can be more than one instance or copy of a given computer program executing on the collection of servers at any given time. Multiple copies of a computer program that implements a data transformation task, for instance, can be executing at the same time on one or more servers.

In the illustrative example of FIG. 1, user 102 interacts with client device 104 to send training data 120 to data center 108. Data center 108 receives training data 120. Data center 108 stores predictive models 112a . . . 112n, including, e.g., information indicative of numerous types of predictive models. Predictive models 112a . . . 112n include models that may be trained using training data 120. To select one of (and/or a plurality of) predictive models 112a . . . 112n for application to training data 120, data center 108 includes decision engine 114 and model selection rules 116. In some examples, model selection rules 116 may include a mapping of attributes of training data to types of predictive models that provide increased performance for training data with those attributes. Generally, a mapping includes information specifying a relationship between two items of data.

Decision engine 114 is configured to obtain model selection rules 116, to execute model selection rules 116, and to determine one of predictive models 112a . . . 112n that provides increased performance for training data 120, e.g., relative to the performance provided by the other predictive models 112a . . . 112n. In the illustrative example of FIG. 1, decision engine 114 determines that predictive model 112a provides an increased likelihood of increased performance for training data 120, relative to the performance provided by the other predictive models, namely, predictive models 120b . . . 120n.

An example of model selection rules 116 is provided in the below Table 2.

TABLE 2

| ATTRIBUTE OF TRAINING DATA | TYPE OF PREDICTIVE MODEL |
|---|---|
| More than One-Hundred Different | K-Nearest Neighbor |
| Categories | |
| Equal to or Less than One-Hundred | Logistic Regression |
| Different Categories | |
| One category has at least twice | K-Nearest Neighbor or |
| as many examples as any other | Logistic Regression |
| category | |

As illustrated in the above Table 2, model selection rules 116 may include a mapping between the number of categories included in training data 120 and the type of predictive model. In this example, model selection rules 116 specify that when training data 120 includes more than one-hundred, different categories that the k-nearest neighbor predictive model or the logistic regression predictive model provides increased performance in generating predictions for input data, relative to the performance provided by other predictive models. The above Table 2 also specifies that when training data 120 includes less than one-hundred, different categories that the logistic regression predictive model provides increased performance in generating predictions for input data, relative to the performance provided by other predictive models.

The above Table 2 also specifies that when one category has at least twice as many examples as any other category that the k-nearest neighbor predictive model or the logistic regression predictive model provides increased performance in generating predictions for input data, relative to the performance provided by other predictive models.

In an example, model selection rules 116 may be based on numerous other attributes of training data, including, e.g., a size of the training data, an estimate of an amount of time required to train a predictive model using the training data, a number of examples provided per category, a number of features in the training data, and density of training data (e.g., information specifying how spread out are the training data). In an example, houses represent training data, and the density is indicative of whether a house is in an urban area, a rural area, and so forth. In this example, houses in the urban area have increased density, e.g., relative to houses in the rural area.

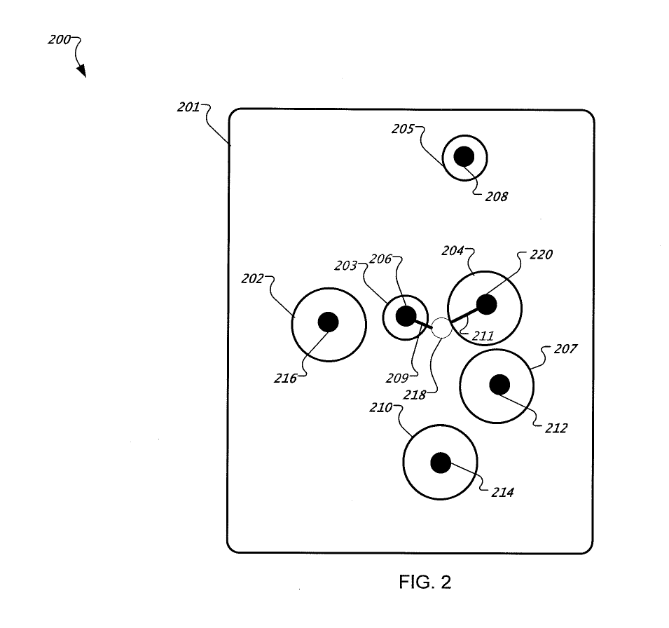

FIG. 2 illustrates contents of mapping 200 in a k-nearest neighbor predictive model. When decision engine 114 selects the k-nearest neighbor predictive model for training data 120, decision engine 114 plots items of training data in training space 201. Training data 120 includes items 206, 208, 212, 214, 216, 220. Each of items 206, 208, 212, 214, 216, 220 corresponds to one of the examples included in Table 1. For example, item 206 corresponds to example 4. Item 208 corresponds to example 5. Items 212, 214, 216, 220 correspond to examples 1-3 and 6, respectively.

In the illustrative example of FIG. 2, mapping 200 also includes item 218 of input data. Item 218 of input data is an email message with the following subject line: “Secrets of extreme, lowest interest rates ever! Act fast! Don't lose this opportunity!” In this example, item 218 of input data is received by decision engine 114 from client device 104. Decision engine 114 uses mapping 200 in predicting whether item 218 of input data is “spam” or “not spam.”

As previously described, decision engine 114 obtains a utility function for training data 120. The utility function is either automatically generated by decision engine 114 and/or specified by a user. The utility function includes weighted values specifying how important it is to correctly categorize examples of a specific category, e.g., the spam category and the not spam category. In an example, decision engine 114 obtains the utility function from user input specifying how important it is to correctly categorize examples of a specific category. Decision engine 114 generates the utility function by determining weighted values in accordance with the user input.

In an example, a utility function specifies that a spam item is assigned a value of two and non-spam items are assigned a value of five. In this example, items 206, 208 are non-spam items and are assigned values of two. Items 212, 214, 216, 220 are spam items and are assigned values of five. In this example, decision engine 114 applies the utility function to items 206, 208, 212, 214, 216, 220 and determines the weighted values for items 206, 208, 212, 214, 216, 220 in accordance with the foregoing values

In accordance with the utility function, items 212, 214, 216, 220 are assigned weighted values specifying that items 212, 214, 216, 220 are two and one half times as important as items 206, 208, because the utility function specifies that is more important to correctly category items of spam than it is to correctly categorize items of non-spam.

Using the weighted values in the utility function, decision engine 114 applies the weighted values to items 206, 208, 212, 214, 216, 220. In an example, decision engine 114 applies the weighted values by expanding the circumference of items 206, 208, 212, 214, 216, 220 in accordance with the respective weighted values. In FIG. 2, decision engine 114 generates circumference areas 203, 205 around items 206, 208, respectively. As previously described, the utility function assigns the spam category (and items in that category) a value of five. The utility function also assigns the non-spam category (and items in that category) a value of two. In this example, the size of circumference areas 203, 205 is in accordance with the weighted values specifying that categorization of non-spam items (e.g., items 206, 208) is half as important as categorization of spam items.

Decision engine 114 also generates circumference areas 202, 204, 207, 210 around items 216, 220, 212, 214, respectively. The size of circumference areas 202, 204, 207, 210 is in accordance with the weighted values specifying that categorization of spam items (e.g., items 216, 220, 212, 214) is twice as important as categorization of non-spam items. In the example of FIG. 2, circumference areas 202, 204, 207, 210 are twice the size of circumference areas 203, 205.

To predict a category of either “spam” or “not spam” for item 218, decision engine 114 uses mapping 200 in executing the k-nearest neighbor prediction model. In implementing the k-nearest neighbor prediction model (e.g., without a utility function), decision engine 114 calculates distances between each of items 206, 208, 212, 214, 216, 220 and item 218 of input data. In this example, decision engine 114 determines that items 206, 220 are closest to item 218 of input data, e.g., relative to closeness of items 208, 212, 214, 216 to item 218 of input data. Decision engine 114 determines distance metric 209 between item 206 and item 218 of input data. Decision engine 114 determines distance metric 211 between item 220 and item 218 of input data. In this example, item 206 is closest to item 218 of input data, e.g., relative to a closeness of item 220 (and/or any of other items 212, 214, 216) to item 218 of input data, as indicated by distance metric 209 being shorter than distance metric 211. In this example, item 206 is the nearest neighbor to item 218 of input data.

As previously described, decision engine 114 may apply a utility function to extend the circumferences of items 206, 208, 214, 216, 220 to circumference areas 203, 205, 207, 210, 202, 204, respectively. Decision engine 114 calculates the distance from each of circumference areas 203, 205, 207, 210, 202, 204 to item 218.

In this example, the distance between item 218 of input data and circumference area 204 is the shortest distance relative to the other distances from item 218 to circumference areas 203, 205, 207, 210, 202, 204. In this example, circumference area 204 touches item 218. Circumference area 203 for item 206 (e.g., the nearest neighbor in the above example) is further away from item 218 of input data than circumference area 204, making item 206 not the nearest neighbor to item 218 of input data in this example. Circumference area 204 encompasses item 220, making item 220 the nearest neighbor to item 218 of input data, e.g., rather than item 206 when decision engine 114 executes the k-nearest neighbor predictive model without a utility function.

In the example of FIG. 2, decision engine 114 generates a prediction that item 218 is associated with the same category as item 220. As previously described, item 220 is categorized as spam. In accordance with the categorization for item 220 as spam, decision engine 114 also categories item 218 of input data as spam.

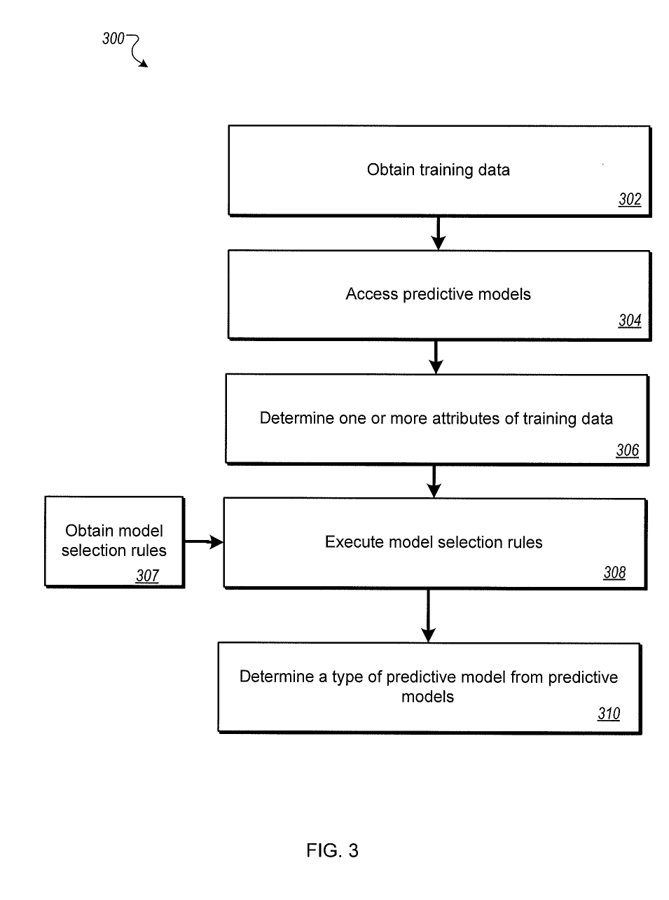

In a variation of FIG. 2, decision engine 114 uses the training data to determine various patterns (e.g., keywords, sequences of words, etc.) associated with various categories. Decision engine 114 plots items representing the various patterns in a plot (e.g., training space 201). Decision engine 114 expands circumferences of the plotted items in accordance with the weighted values, using the techniques described above. In this example, the predictive model includes the plot of the various items representing patterns and the expanded circumferences of the various items. FIG. 3 is a flowchart of an example process 300 for determining a type of predictive model to be applied to training data 120. In operation, data center 108 receives (302) training data 120 from client device 104. In response to receipt of training data 120, decision engine 114 accesses (304) predictive models 112a . . . 112n. Decision engine 114 also determines (306) one or more attributes of training data 120, including, e.g., a size of training data 120, an estimate of an amount of time required to train a predictive model using training data 120, a number of categories included in training data 120, a number of examples provided per category, and a number of features in training data 120.

Decision engine 114 obtains (307) model selection rules 116, for example, from a data repository (not shown). Decision engine 114 executes (308) model selection rules 116, for example, as previously described. Based on execution of model selection rules 116, decision engine 114 determines (310) types of predictive models to be applied to training data 120 from predictive models 112a . . . 112n.

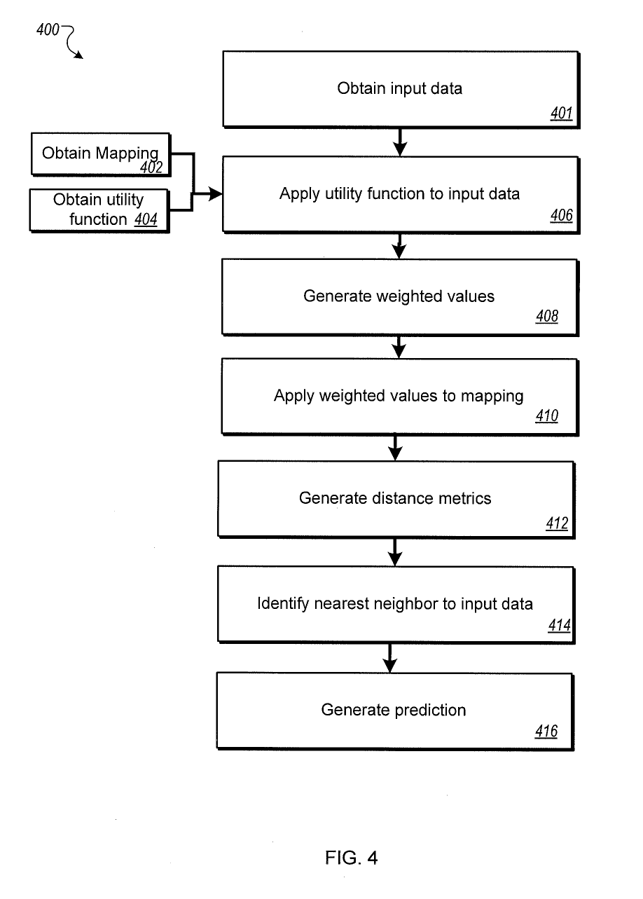

FIG. 4 is a flowchart of an example process 400 for using a utility function in a k-nearest neighbor predictive model. In operation, decision engine 114 receives (401) item 218 (FIG. 2) of input data. In this example, training data 120 is used in generating a prediction of a category for item 218 of input data. Through execution of actions 302, 304, 306, 308, 310 (FIG. 3), decision engine 114 determines that the k-nearest neighbor predictive model is used for training data 120 and thus in generating a prediction for item 218.

Decision engine 114 obtains (402) mapping 200, for example, from a data repository included in data center 108. Decision engine 114 also obtains (404) a utility function for the k-nearest neighbor predictive model, including, e.g., the utility function described above. Decision engine 114 applies (406) the utility function to item 218 of input data. Using the utility function, decision engine 114 generates (408) weighted values for items 206, 208, 214, 216, 220, for example, as described above. Using the weighted values, decision engine 114 applies (410) the weighted values to mapping 200, for example by, encompassing items 206, 208, 212, 214, 216, 220 in circumference areas 203, 205, 207, 210, 202, 204, respectively.

Decision engine 114 also generates (412) distance metrics (not shown) indicative of distances between item 218 and each of circumference areas 203, 205, 207, 210, 202, 204. Using the distance metrics, decision engine 114 identifies (414) a nearest neighbor of item 218. In the illustrative example of FIG. 2, item 220 (with circumference area 204) is the nearest neighbor of item 218. Decision engine 114 generates (416) a prediction of a category for item 218 of input data. In an example, decision engine 114 generates the prediction by assigning item 218 to the category associated with the nearest neighbor. In this example, item 220 is categorized as spam. Based on the categorization of item 220 as spam, decision engine 114 generates a prediction that item 218 is also spam.

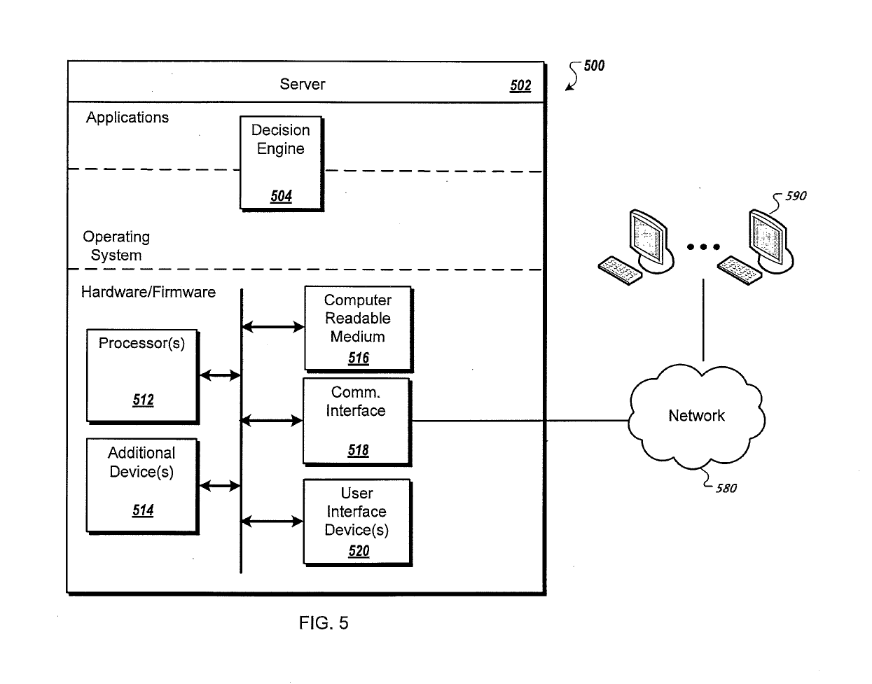

FIG. 5 is a schematic diagram of an example server. The server 502 is optionally connected to one or more user or client computers 590 through a network 580. The server 502 consists of one or more data processing apparatuses. While only one data processing apparatus is shown in FIG. 5, multiple data processing apparatus can be used. The server 502 includes various software modules, e.g. executable software programs or libraries, including one or more of: a model importer 504, a model implementation 506, an implementation selector 508, and a model executer 510. Although several software modules are illustrated, there may be fewer or more software modules. Moreover, the software modules can be distributed on one or more data processing apparatus connected by one or more networks or other suitable communication mediums.

The server 502 also includes hardware or firmware devices including one or more processors 512, one or more additional devices 514, a computer readable medium 516, a communication interface 518, and one or more user interface devices 520. Each processor 512 is capable of processing instructions for execution within the server 502. In some implementations, the processor 512 is a single or multi-threaded processor. Each processor 512 is capable of processing instructions stored on the computer readable medium 516 or on a storage device such as one of the additional devices 414. The server 502 uses its communication interface 518 to communicate with one or more computers 590, for example, over a network 580. Examples of user interface devices 520 include a display, a camera, a speaker, a microphone, a tactile feedback device, a keyboard, and a mouse. The server 502 can store instructions that implement operations associated with the modules described above, for example, on the computer readable medium 516 or one or more additional devices 514, for example, one or more of a floppy disk device, a hard disk device, an optical disk device, or a tape device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification includes many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, in a system of one or more computers, a set of training data for predictive modeling;
determining, by the system, one or more attributes of the training data;
identifying, by the system in a mapping of attributes to types of predictive models, a type of predictive model that is mapped to at least one of the one or more attributes;
obtaining a utility function that specifies a first weighted value to be applied to a first item of training data in the set and that further specifies a second, different weighted value to be applied to a second, different item of training data in the set, with a weighted value for an item of training data specifying an importance of the item of training data, relative to another importance of another item of training data;
assigning, based on the utility function, (i) the first weighted value to the first item of training data in the set, and (ii) the second, different weighted value to the second, different item of training data in the set; and
training, based on assigning the first and second weighted values, a predictive model of the identified type.

2. (canceled)

3. The computer-implemented method of claim 1, wherein training comprises:
determining one or more patterns in the training data.

4. The computer-implemented method of claim 1, wherein the identified type of predictive model comprises one or more of a k-nearest neighbor predictive model, a logistic regression predictive model, a Naive Bayes predictive model, and a support vector predictive model.

5. The computer-implemented method of claim 1, wherein the one or more attributes comprise one or more of a size of the training data, an estimate of an amount of time required to train a predictive model with the training data, a number of categories in the training data, and a number of features of the training data.

6. The computer-implemented method of claim 1, wherein the predictive model of the identified type comprises a k-nearest neighbor predictive model, and wherein the method further comprises:
receiving input data;
identifying, from the k-nearest neighbor predictive model, a k-nearest item of data that is closest to the input data, relative to closeness of other k-nearest items of data to the input data; and
assigning to the input data a category associated with the identified k-nearest item data.

7. A system comprising:
one or more computers; and
one or more storage devices storing instructions that are executable by the one or more computers to perform operations comprising:
receiving a set of training data for predictive modeling;
determining one or more attributes of the training data;
identifying, in a mapping of attributes to types of predictive models, a type of predictive model that is mapped to at least one of the one or more attributes;
obtaining a utility function that specifies a first weighted value to be applied to a first item of training data in the set and that further specifies a second, different weighted value to be applied to a second, different item of training data in the set, with a weighted value for an item of training data specifying an importance of the item of training data, relative to another importance of another item of training data;
assigning, based on the utility function, (i) the first weighted value to the first item of training data in the set, and (ii) the second, different weighted value to the second, different item of training data in the set; and
training, based on assigning the first and second weighted values, a predictive model of the identified type.

8. (canceled)

9. The system of claim 7, wherein training comprises:
determining one or more patterns in the training data.

10. The system of claim 7, wherein the identified type of predictive model comprises one or more of a k-nearest neighbor predictive model, a logistic regression predictive model, a Naive Bayes predictive model, and a support vector predictive model.

11. The system of claim 7, wherein the one or more attributes comprise one or more of a size of the training data, an estimate of an amount of time required to train a predictive model with the training data, a number of categories in the training data, and a number of features of the training data.

12. The system of claim 7, wherein the predictive model of the identified type comprises a k-nearest neighbor predictive model, and wherein the operations further comprise:
receiving input data;
identifying, from the k-nearest neighbor predictive model, a k-nearest item of data that is closest to the input data, relative to closeness of other k-nearest items of data to the input data; and
assigning to the input data a category associated with the identified k-nearest item data.

13. One or more storage devices storing instructions that are executable by one or more computers to perform operations comprising:
receiving a set of training data for predictive modeling;
determining one or more attributes of the training data;
identifying, in a mapping of attributes to types of predictive models, a type of predictive model that is mapped to at least one of the one or more attributes;
obtaining a utility function that specifies a first weighted value to be applied to a first item of training data in the set and that further specifies a second, different weighted value to be applied to a second, different item of training data in the set, with a weighted value for an item of training data specifying an importance of the item of training data, relative to another importance of another item of training data;
assigning, based on the utility function, (i) the first weighted value to the first item of training data in the set, and (ii) the second, different weighted value to the second, different item of training data in the set; and
training, based on assigning the first and second weighted values, a predictive model of the identified type.

14. (canceled)

15. The one or more storage devices of claim 13, wherein training comprises:
determining one or more patterns in the training data.

16. The one or more storage devices of claim 13, wherein the identified type of predictive model comprises one or more of a k-nearest neighbor predictive model, a logistic regression predictive model, a Naive Bayes predictive model, and a support vector predictive model.

17. The one or more storage devices of claim 13, wherein the one or more attributes comprise one or more of a size of the training data, an estimate of an amount of time required to train a predictive model with the training data, a number of categories in the training data, and a number of features of the training data.

18. The one or more storage devices of claim 13, wherein the predictive model of the identified type comprises a k-nearest neighbor predictive model, and wherein the operations further comprise:
receiving input data;
identifying, from the k-nearest neighbor predictive model, a k-nearest item of data that is closest to the input data, relative to closeness of other k-nearest items of data to the input data; and
assigning to the input data a category associated with the identified k-nearest item data.

19. A system comprising:
means for receiving a set of training data for predictive modeling;
means for determining one or more attributes of the training data;
means for identifying, in a mapping of attributes to types of predictive models, a type of predictive model that is mapped to at least one of the one or more attributes;
means for obtaining a utility function that specifies a first weighted value to be applied to a first item of training data in the set and that further specifies a second, different weighted value to be applied to a second, different item of training data in the set, with a weighted value for an item of training data specifying an importance of the item of training data, relative to another importance of another item of training data;
means for assigning, based on the utility function, (i) the first weighted value to the first item of training data in the set, and (ii) the second, different weighted value to the second, different item of training data in the set; and
means for training, based on assigning the first and second weighted values, a predictive model of the identified type.
